(19) United States
(12) Patent Application Publication
(10) Pub. No.: US 2017/0193523 A1
(43) Pub. Date: Jul. 6, 2017

(54) DRIVER SCREENING INCLUDING MENTORING

(71) Applicant: Lyft, Inc., San Francisco, CA (US)

(72) Inventors: Evan Goldin, San Francisco, CA (US); Frank Taehyun Yoo, Cupertino, CA (US); Marc Haumann, San Francisco, CA (US); Travis VanderZanden, Lafayette, CA (US); Logan Green, San Francisco, CA (US)

(21) Appl. No.: 14/455,010

(22) Filed: Aug. 8, 2014

Related U.S. Application Data
(60) Provisional application No. 61/968,170, filed on Mar. 20, 2014.

(51) Int. Cl. G06Q 30/00

(52) U.S. Cl. CPC G06Q 30/018

(57) ABSTRACT

A system for driver screening comprises an input interface and a processor. The system is configured to receive a driver application and to receive an indication to start a test drive with a mentor. The processor configured to determine if the test drive was successful and to determine if the driver is approved to drive.

### CROSS REFERENCE TO OTHER APPLICATIONS

This application claims priority to U.S. Provisional Patent Application No. 61/968,170 entitled DRIVER SCREENING INCLUDING MENTORING filed Mar. 20, 2014 which is incorporated herein by reference for all purposes.

### BACKGROUND OF THE INVENTION

A system for sharing rides includes a system for screening new drivers to ensure that only safe drivers are giving rides. A basic system for sharing rides includes dedicated staff for managing the driver screening process and observing the driver skills. As the system grows, the dedicated staff must grow in turn, increasing the business overhead.

### BRIEF DESCRIPTION OF THE DRAWINGS

Various embodiments of the invention are disclosed in the following detailed description and the accompanying drawings.

FIG. 1 is a block diagram illustrating an embodiment of a system for connecting a driver and a rider.

FIG. 2 is a block diagram illustrating an embodiment of a ride management system.

FIG. 3 is a block diagram illustrating an embodiment of a user system.

FIG. 4 is a diagram illustrating an embodiment of a user device display for indicating a pickup address to a rider system.

FIG. 5 is a flow diagram illustrating an embodiment of a process for becoming a driver.

FIG. 6 is a flow diagram illustrating an embodiment of a process for mentoring.

FIG. 7 is a flow diagram illustrating an embodiment of a process for driver screening including mentoring.

FIG. 8 is a flow diagram illustrating an embodiment of a process for determining whether a user is approved to drive.

FIG. 9 is a diagram illustrating an embodiment of a system for driver screening.

FIG. 10 is a diagram illustrating an embodiment of a system for driver screening.

FIG. 11 is a diagram illustrating an embodiment of a system for driver screening.

FIG. 12 is a diagram illustrating an embodiment of a system for driver screening.

FIG. 13 is a diagram illustrating an embodiment of a system for driver screening.

FIG. 14 is a diagram illustrating an embodiment of a system for driver screening.

FIG. 15 is a diagram illustrating an embodiment of a system for driver screening.

FIG. 16 is a diagram illustrating an embodiment of a system for driver screening.

FIG. 17 is a diagram illustrating an embodiment of a system for driver screening.

FIG. 18 is a diagram illustrating an embodiment of a system for driver screening.

FIG. 19 is a diagram illustrating an embodiment of a system for driver screening.

FIG. 20 is a diagram illustrating an embodiment of a system for driver screening.

FIG. 21 is a diagram illustrating an embodiment of a system for driver screening.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Driver screening including mentoring is disclosed. A system for driver screening comprises an input interface configured to receive a driver application and to receive an indication to start a test drive with a mentor. The system for driver screening comprises a processor configured to determine if the test drive was successful and to determine if the driver is approved to drive. The system for driver screening additionally comprises a memory coupled to the processor and configured to provide the processor with instructions.

In some embodiments, a system for coordinating ride sharing between a set of established drivers and a set of prospective riders includes a system for driver screening including mentoring. A system for driver screening including mentoring uses an automated system for managing a driver application process. The automated system manages driver application checks (e.g., is the user old enough, is the user's car new enough, etc.) as well as background checks (e.g., department of motor vehicles (DMV) checks, criminal background checks, etc.). The automated system additionally coordinates a mentoring process. The mentoring process connects an established mentor with the user applying to be a driver. A mentor is a driver that is willing to act as a mentor to driver applicants. After a user applying to be a driver fills in an application form, he indicates to take a test drive with a mentor. The system for coordinating ride sharing connects the user with a driver that is willing to act as a mentor, and the user performs a test drive for the mentor. In some embodiments, the mentor submits information describing the driver, the car, and the ride to the system. In the event the user passes the driver application checks, the background checks, and the test drive, the system indicates to the user that the user is allowed to become a driver. In some embodiments, the order of performance of the automated checks is performed in an order to use resources appropriately—for example, expensive or scarce resources later or last in the process so that less expensive or available resources have already screened out some potential drivers. In some embodiments, the background checks are not performed immediately upon receipt of a driver application from a user, in order to avoid wasting the resources of performing the checks (e.g., the background checks cost money to perform) on a user that does not follow through with the application or fails the test drive.

In some embodiments, driver screening is reperformed (e.g., periodically, annually, upon indication of a problem, etc.). In some embodiments, driver screening comprises doing the mentor driver screening again. In some embodiments, a car inspection is reperformed (e.g., periodically, annually, upon indication of a problem, etc.). In some embodiments, car inspection comprises doing the mentor driver car inspection again.

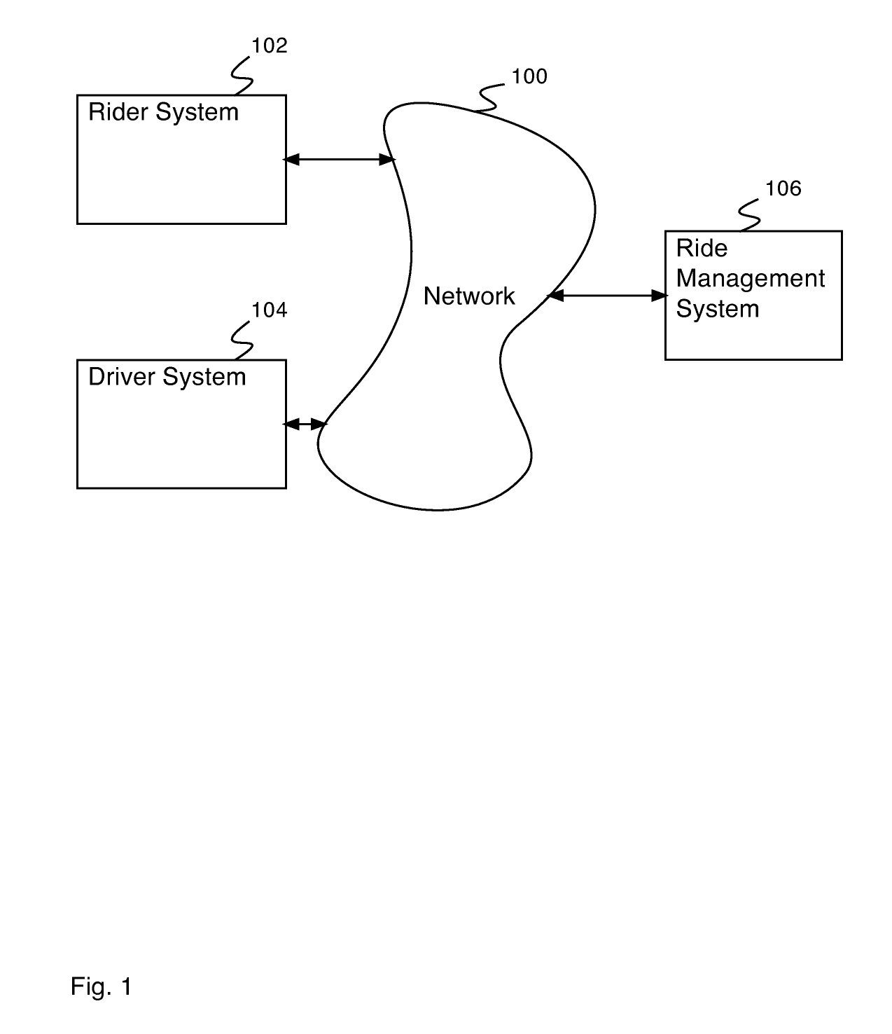

FIG. 1 is a block diagram illustrating an embodiment of a system for connecting a driver and a rider. In the example shown, FIG. 1 comprises network 100. In various embodiments, network 100 comprises one or more of the following: a local area network, a wide area network, a wired network, a wireless network, the Internet, an intranet, a storage area network, a cellular network, or any other appropriate communication network. Rider system 102 and driver system 104 comprise user systems (e.g., computing systems for operation by users). In some embodiments, one or more of rider system 102 and driver system 104 comprises a system accessed by a user directly (e.g., the user is in proximity with the user system). In some embodiments, one or more of user system 102 and user system 104 comprises a system accessed by a user remotely (e.g., the user is not in proximity with the user system, and accesses the user system via network 100 and a separate user system). In the example shown, rider system 102 and driver system 104 comprise mobile devices (e.g., smartphones, tablet computers, etc.). Rider system 102 and driver system 104 comprise systems accessing ride management system 106 (e.g., accessing ride management system 106 via network 100). In various embodiments, there are 2, 5, 22, 122, 4320, 26100, or any other appropriate number of or plurality of user systems (e.g., rider systems and driver systems) accessing ride management system 106. Ride management system 106 comprises a system for managing drivers giving riders rides. In some embodiments, ride management system 106 comprises a system for connecting a rider and a driver. In some embodiments, ride management system 106 comprises a system for managing rider donations. In some embodiments, ride management system 106 comprises a system for dispatching drivers. In some embodiments, ride management system 106 comprises a system for driver screening including mentoring. In various embodiments, ride management system 106 comprises a computer, a computer with multiple processors, multiple computers connected via a local network, multiple computers connected via a wide area network, multiple computers connected via the Internet, multiple computers connected via network 100, or any other appropriate computing system or systems. In various embodiments, the processors comprising rider system 102, driver system 104, and ride management system 106 comprise any one of a variety of proprietary or commercially available single or multi-processor systems (e.g., an Intel™-based processor) or other type of commercially available processor able to support communications in accordance with each particular embodiment and application.

In some embodiments, rider system 102 is used by a potential driver that desires to be screened as a driver. In some embodiments, driver system 104 is used by a mentor that screens a potential driver. In some embodiments, ride management system 106 provides an automated system for managing driver screening including interfacing with rider system 102 and driver system 104.

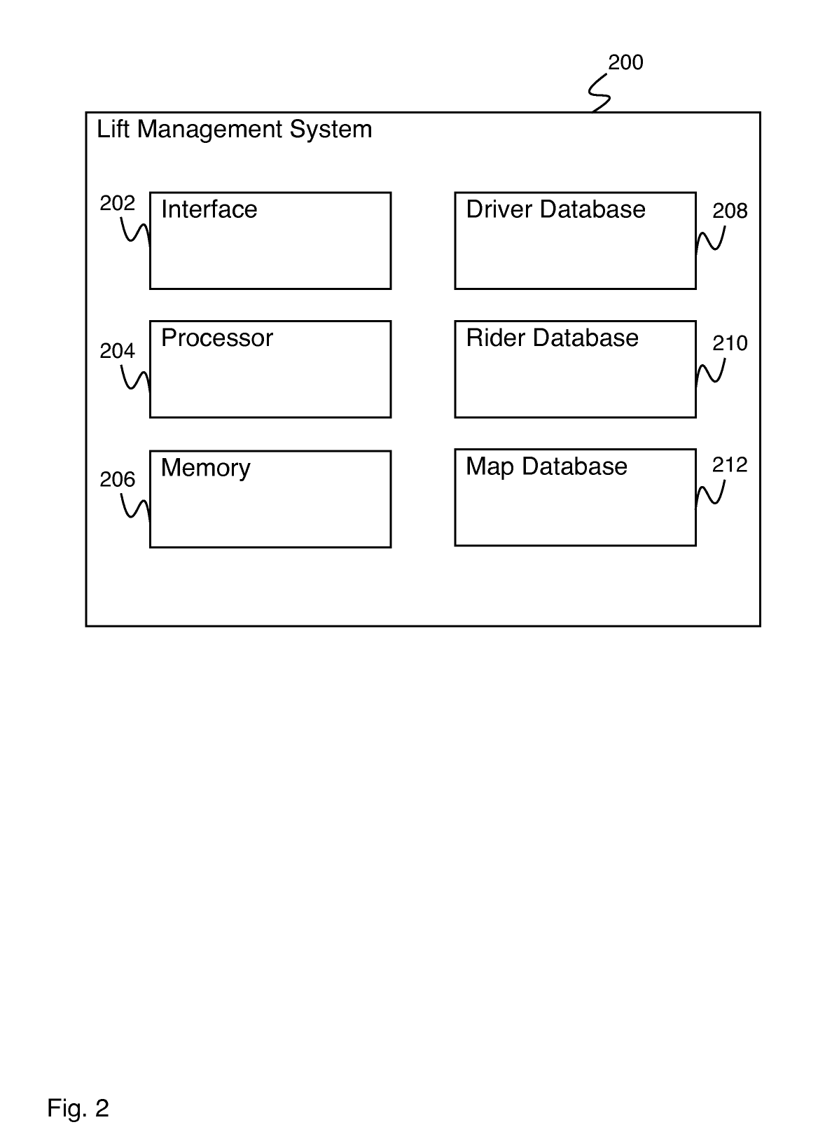

FIG. 2 is a block diagram illustrating an embodiment of a ride management system. In some embodiments, ride management system 200 comprises ride management system 106 of FIG. 1. In the example shown, ride management system 200 comprises interface 202. In various embodiments, interface 202 comprises an interface for receiving ride requests, sending rider notifications, receiving rider accept and deny indications, sending connect notifications, receiving location information, sending and receiving ride start notifications, sending and receiving ride complete notifications, sending and receiving donation information, sending and receiving driver rating information, sending and receiving rider rating information, sending donation summary information, sending and receiving test drive requests, sending and receiving driver approval information, receiving driver application information, providing driver tutorial videos, requesting a department of motor vehicles (DMV) background check, requesting a criminal background check, or sending or receiving any other appropriate information. In some embodiments, interface 202 communicates with a user system (e.g., a driver mobile device or a rider mobile device) via a network. Processor 204 comprises a processor for receiving and processing and providing information. In some embodiments, processor 204 communicates with interface 202. Processor 204 receives information from interface 202 and determines what information should be sent by interface 202. In some embodiments, processor 204 determines whether a driver is offered a request from a rider. Memory 206 comprises a memory coupled to processor 204 and configured to provide processor 204 with instructions. Driver database 208 comprises driver information (e.g., driver names, driver schedules, driver histories, driver ratings, driver donation amounts, driver images, driver car images, etc.) Rider database comprises rider information (e.g., rider names, rider histories, rider ratings, rider donation amounts, rider images, etc.). Map database 212 comprises map information. In some embodiments, processor 204 uses map information from map database 212 to plan routes.

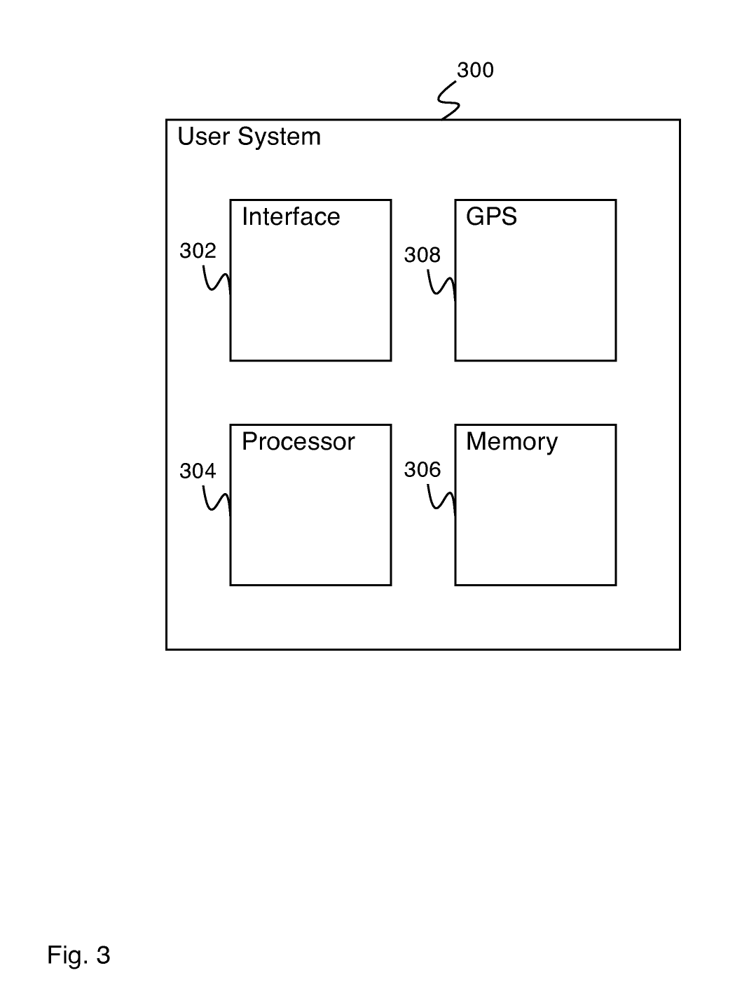

FIG. 3 is a block diagram illustrating an embodiment of a user system. In some embodiments, user system 300 of FIG. 3 comprises rider system 102 of FIG. 1. In some embodiments, user system 300 of FIG. 3 comprises driver system 104 of FIG. 1. In the example shown, user system 300 comprises interface 302. In various embodiments, interface 302 comprises an interface for sending ride requests, receiving rider notifications, sending rider accept and deny indications, receiving connect notifications, sending location information, sending and receiving ride start notifications, sending and receiving ride complete notifications, sending and receiving donation information, sending and receiving driver rating information, sending and receiving rider rating information, receiving donation summary information, or sending or receiving any other appropriate information. Processor 304 receives information from interface 302 and determines what information should be sent by interface 302. Memory 306 comprises a memory coupled to processor 304 and configured to provide processor 304 with instructions. GPS (e.g., global positioning system) 308 comprises a GPS for determining a user system position. In some embodiments, GPS position information is transmitted by interface 302 to a ride management system. In various embodiments, user system 300 comprises a mobile device, a cellular phone, a tablet, a mobile communication device, a portable computer, or any other appropriate user system.

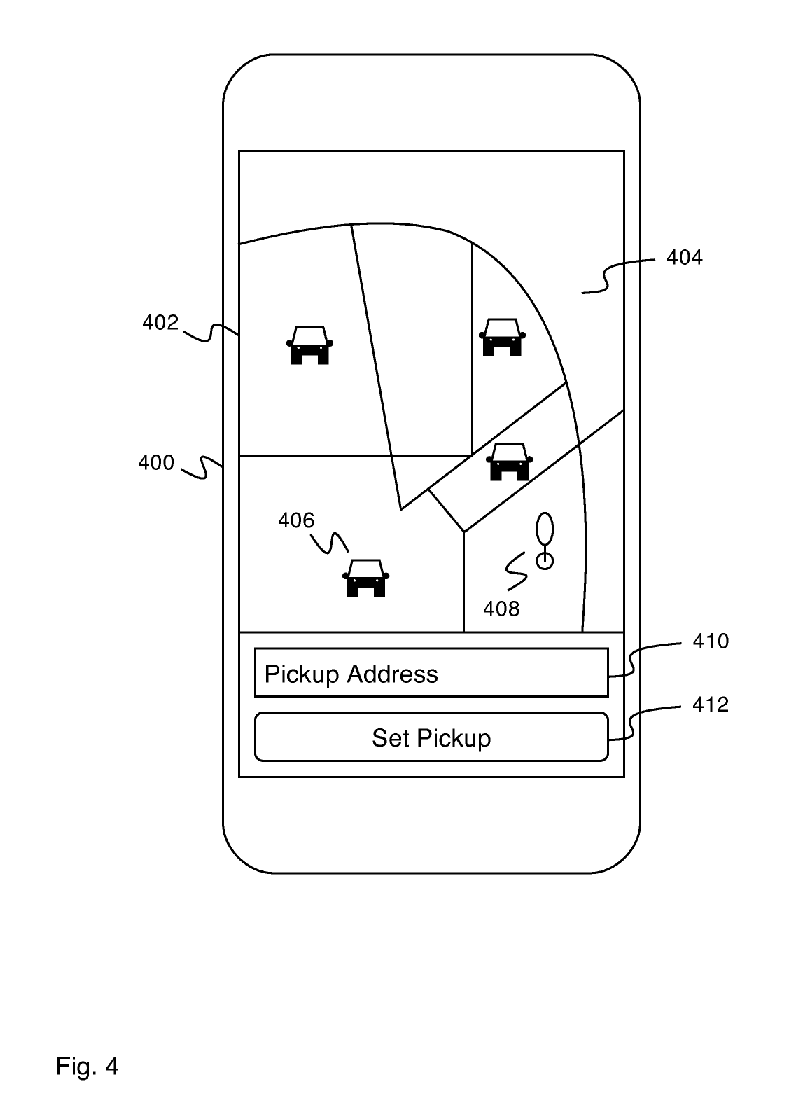

FIG. 4 is a diagram illustrating an embodiment of a user device display for indicating a pickup address to a rider system. In some embodiments, the diagram of FIG. 4 illustrates the display of rider system 102 of FIG. 1. In the example shown, rider system 400 comprises display 402. Display 402 comprises a default display for a rider system. Display 402 comprises map 404, displaying the local area around the rider system. Map 404 comprises local roads and geographical features, car icons indicating active driver systems (e.g., car icon 406) and a pin icon indicating the rider system position (e.g., pin icon 408). In some embodiments, the set of car icons indicating active driver systems comprises a set of potential drivers. Display 402 additionally comprises pickup address entry field 410 and set pickup button 412. Pickup address entry field 410 comprises a field for a rider to enter an address to be picked up at. In some embodiments, a rider types a pickup address into pickup address entry field 410. In some embodiments, pickup address entry field 410 defaults to a default pickup address. In some embodiments, the default pickup address is the rider current address. In some embodiments, the default pickup address comprises an address derived from the rider current address (e.g., an address cluster lead location). In some embodiments, the default pickup address comprises a commonly used pickup address (e.g., a convenient pickup location near by the user's current location). In some embodiments, the rider can access a list of commonly used pickup addresses (e.g., by tapping on pickup address entry field 410, by swiping up on map 404, by tapping on a commonly used addresses button, or by performing any other appropriate user interface action). Set pickup button 412 initiates request of a ride using the currently entered or selected pickup address.

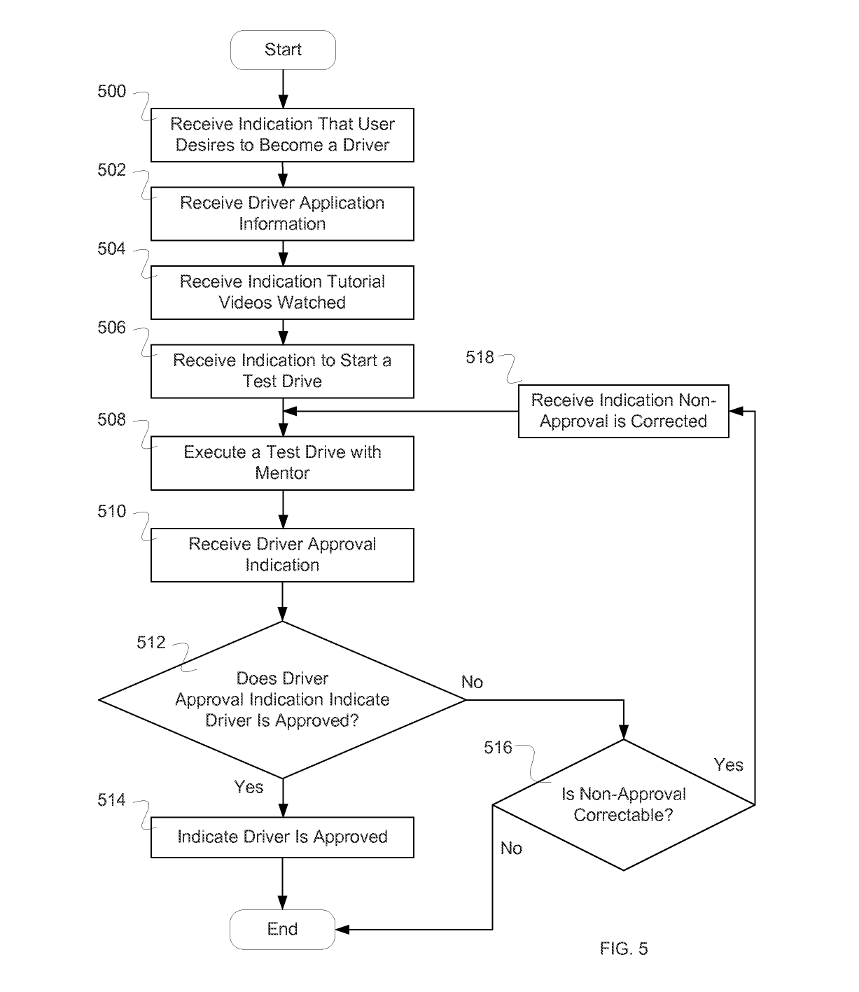

FIG. 5 is a flow diagram illustrating an embodiment of a process for becoming a driver. In some embodiments, the process of FIG. 5 includes driver screening including mentoring. In some embodiments, the process of FIG. 5 is executed by a user interacting with a user system (e.g., user system 300 of FIG. 3). In the example shown, in 500, receive an indication that the user desires to become a driver. In some embodiments, the user indicates to become a driver by making an indication to a “Become A Driver” button on a user interface on the user system, and this indication is received by the system. In some embodiments, in response to the user indicating to become a driver, the user system displays a driver application for the user. In 502, driver application information is received. For example, the user provides driver application information (e.g., provides information as requested by the driver application). In various embodiments, driver application information received comprises an age, an address, a driver's license number, vehicle information (e.g., make, model, year, number of doors, vehicle identification number, etc.), social media information, consent for a DMV background check, consent for a criminal background check, or any other appropriate information. In 504, receive indication that tutorial videos have been watched. For example, the user watches tutorial videos and an indication is received by the system. In some embodiments, it is determined whether the user has watched the appropriate video(s) and if not the process waits until the videos have been watched—the prospective driver is not allowed to proceed until the videos have been watched determined to be watched.

In 506, indication is received to start a test drive. For example, it is indicated to the user that the user should find a mentor to do a test drive. In some embodiments, a test drive comprises mentoring. In some embodiments, indicating to start a test drive indicates that the user is ready to start a test drive with a mentor. In response to a user indicating to start a test drive, a mentor is determined, if possible and the mentor location is provided to the user. For example, an application identifies a mentor (e.g., an experienced or qualified driver) that is close and currently available to mentor and this driver is checked to see if they would like to do a drive test. In 508, a test drive is executed with the mentor. In some embodiments, executing the test drive with the mentor comprises driving to the mentor location, picking the mentor up, driving the mentor on a test drive, and returning the mentor to the original location. In various embodiments, the test drive includes a mentor taking and providing to the system a driver photo, taking and providing to the system an insurance information photo, taking and providing to the system a registration information photo, taking and providing to the system a vehicle photo, inspecting the vehicle and providing to the system a filled out check list, requesting information from the driver and providing to the system the driver information, or any other appropriate driver testing activity and information providing to the system.

In 510, a driver approval indication is received. A driver approval indication comprises an indication of whether the user is approved as a driver. In various embodiments, the driver approval indication is received immediately after the test drive, minutes after the test drive, hours after the test drive, days after the test drive, or any other appropriate period of time after the test drive. In 512, the user determines whether the driver approval indication indicates the driver is approved. In the event that the driver approval indication indicates that the driver is not approved, in 516 it is determined whether the non-approval is correctable. For example, the mentor driver may indicate a correctable problem (e.g., windshield is cracked, tires have insufficient tread, brake light out, etc.). In the event that the non-approval is correctable, in 518 receive indication non-approval is corrected and control is passed to 508. For example, the system waits to receive an indication that the problem associated with the non-approval has been corrected and then is able to redo a test drive with a mentor driver. In the event that the non-approval is not correctable, the process ends. In various embodiments, a driver approval indication includes indicating that the driver is not approved is as a result of a failed DMV background check, of a failed criminal background check, of a failed test drive, or for any other appropriate reason. In the event that the user determines in 512 that the driver approval indication indicates the driver is approved, control passes to 514. In 514, the user begins driving (e.g., the user becomes a driver).

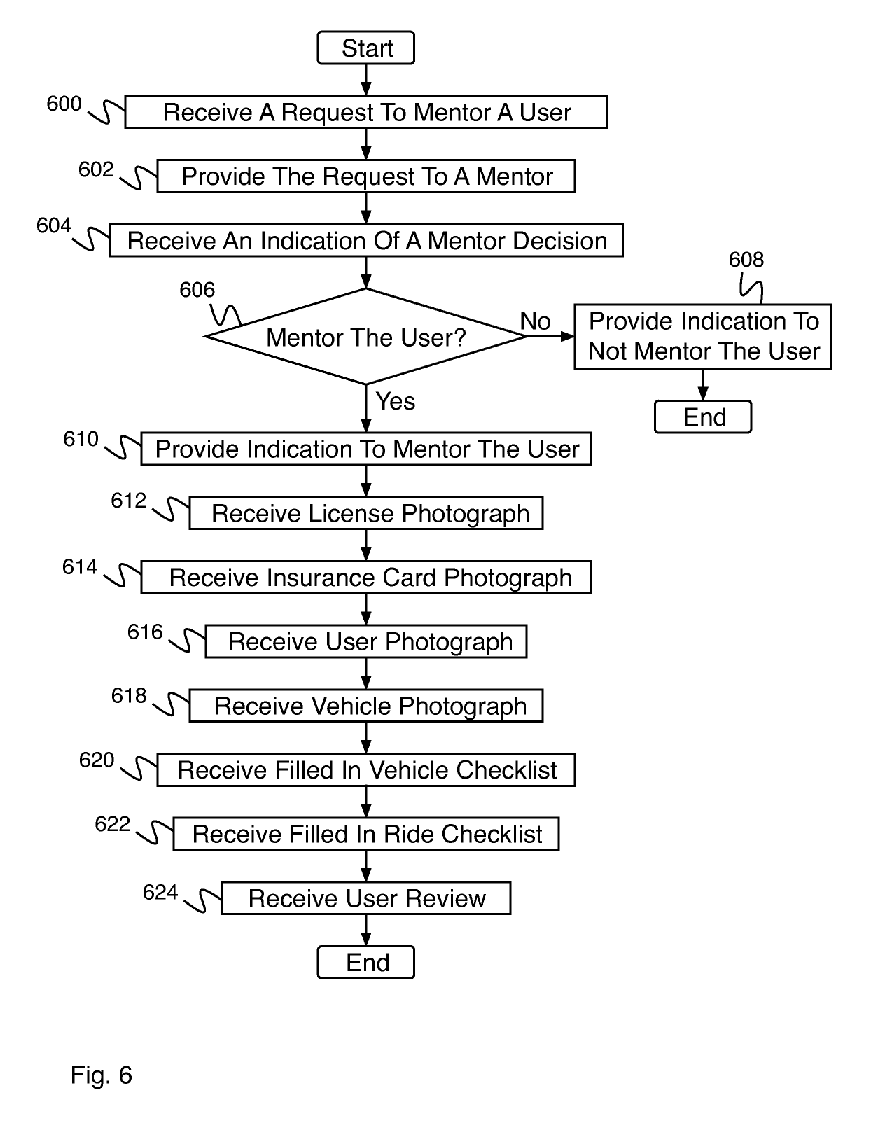

FIG. 6 is a flow diagram illustrating an embodiment of a process for mentoring. In some embodiments, the process of FIG. 6 is executed by a mentor driver using a user system (e.g., user system 300 of FIG. 3). In some embodiments, the process of FIG. 6 comprises a process for a driver mentoring a user in the process of becoming a driver. In the example shown, in 600, a request to mentor a user is received. For example, the driver receives an indication to mentor a user. In some embodiments, the indication to mentor a user is provided to the driver by the user system in response to the user indicating to start a test drive (e.g., indicating to start a test drive in 506 of FIG. 5). In 602, the request is provided to a mentor. In 604, an indication is received of a mentor decision. In 606, it is determined whether or not to mentor the user. In various embodiments, a driver determines whether or not to mentor a user based at least in part on the time of day, the fee for mentoring, the current rate of ride requests, distance to the user, whether the driver enjoys mentoring, the driver's current mood, or any other appropriate criteria. In the event the driver decides not to mentor the user, control passes to 608. In 608, an indication is provided to not mentor the user and the process ends. In some embodiments, in response to the driver indicating to not mentor the user, the indication to mentor the user is provided to a different driver. If the driver determines to mentor the user in 604 control passes to 610. In 610, an indication is provided to mentor the user. For example, the driver indicates approval to mentor the user. In some embodiments, the driver meets the user for mentoring. In some embodiments, the driver meeting the user for mentoring comprises the driver waiting for the user to reach the driver's current location.

In 612, a license photograph is received. For example, a mentor is prompted by the system to take a photo of a driver's license of the prospective driver. In 614, an insurance card photograph is received. For example, a mentor is prompted by the system to take a photo of an insurance card of the prospective driver. In 616, a user photograph is received. For example, a mentor is prompted by the system to take a photo of a prospective driver. In 618, vehicle photograph is received. For example, a mentor is prompted by the system to take a photo of the vehicle of the prospective driver.

In 620, a filled in vehicle checklist is received. For example, a vehicle checklist is filled in and received by the system from the mentor system. In various embodiments, a filled in vehicle checklist includes comprises an entered license plate number, an entered license plate state, a verified current registration, an indication that the user matches a driver's license photo, an indication that the driver's license number matches a previously entered driver's license number, an indication that the vehicle matches a previously taken photo, an indication that the vehicle has at least four doors, an indication that the vehicle body is in good condition, an indication that the tires are in good condition, an indication that the windows and mirrors are not cracked or broken, an indication that the doors function properly, an indication that the windshield wipers are in good working condition, an indication that all lights function properly, verifying the horn works, an indication that the vehicle interior and exterior are clean, an indication that the car smells acceptable, an indication that all seats have functioning safety belts, or any other appropriate vehicle information.

In 622, a filled in ride checklist is received. For example, a mentor driver receives a test drive or ride from the potential driver (e.g., the user of the application) and fills in a ride checklist that is provided to the system from the mentor system. In some embodiments, a test drive comprises a drive where the user drives the mentor driver for a predetermined period of time. In some embodiments, the test drive comprises a loop such that the driver is returned to his car at the end of the test drive. In various embodiments, a ride checklist comprises an indication that the foot brakes are in good or not good working order, an indication that the emergency brake is in good or not good working order, an indication that the engine is quiet and free of rattling or noisy while running, an indication that the steering and handling are in good or not good working condition, an indication that the air conditioning works or does not work properly, an indication that the heating works or does not work properly, or any other appropriate ride information.

In 624, a user review is received. For example, the mentor driver reviews the user and the mentor system provides the review to the system. In various embodiments, a user review includes an indication that the user dress was presentable, an indication that the user hygiene was presentable, an indication that the user communicated well, an indication that the user was friendly, an indication that any passenger would feel comfortable riding with the driver, an indication that the driver obeyed all traffic laws, an estimate for a future driver rating for the user, or any other appropriate review information.

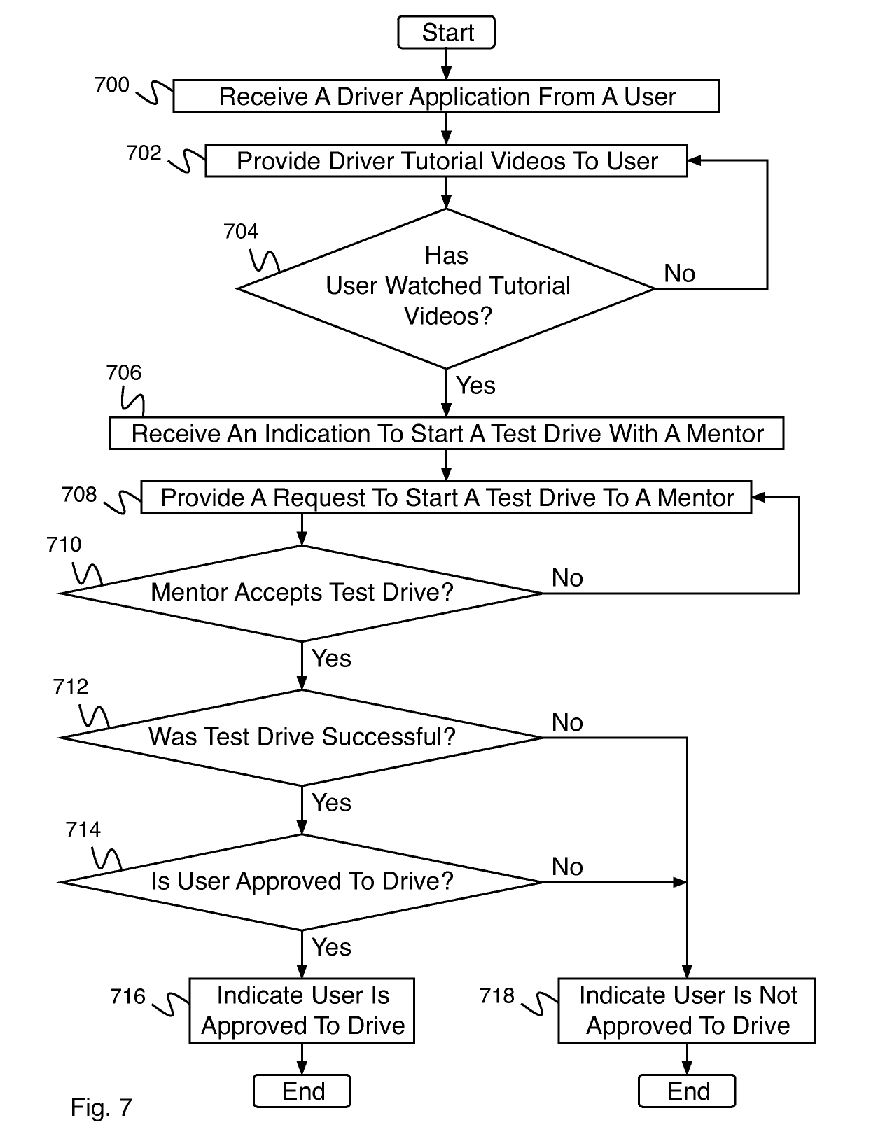

FIG. 7 is a flow diagram illustrating an embodiment of a process for driver screening including mentoring. In some embodiments, the process of FIG. 7 is executed by a ride management system (e.g., ride management system 106 of FIG. 1). In the example shown, in 700, a driver application is received from a user. In 702, tutorial videos are provided to the user. In 704, it is determined whether the driver has watched the tutorial videos. In various embodiments, it is determined whether the user has watched the tutorial videos by determining an amount of time that has passed since providing the tutorial videos, by determining a user data access (e.g., did the user download the video data?), by providing the user with a quiz on the tutorial videos, by determining whether an indication from the user is not received within a predetermined minimum viewing amount of time, by determining whether the user passes a quiz about the videos, or in any other appropriate way. In the event it is determined that the user has not watched the tutorial videos, control passes to 702. In the event it is determined that the user has watched the tutorial videos, control passes to 706. In 706, an indication to start a test driver with a mentor is received (e.g., from the user). In 708, a request to start a test drive is provided to a mentor. In various embodiments, the mentor that the test drive request is provided to comprises a mentor selected at random, comprises the nearest mentor to the user, comprises the highest rated mentor, or comprises any other appropriate mentor. In various embodiments, all drivers are mentors, drivers become mentors after taking a mentor class, drivers become mentors after being drivers for a predetermined period of time, or any other appropriate fraction of drivers comprise mentors. In 710, it is determined whether the mentor accepts the test drive. In some embodiments, it is determined whether the mentor accepts the test drive based on a mentor's response to the request to start a test drive. If it is determined in 710 that the mentor does not accept the test drive, control passes to 708. In some embodiments, in the event 708 is executed multiple times, the mentor provided with the request to start a test drive comprises a mentor not provided with the request during a previous execution of 708. In some embodiments, if there are no mentors not provided with the request during a previous execution of 708, the user is instructed to indicate to start a test drive with a mentor at a different time, and the process ends. If it is determined in 710 that the mentor accepts the test drive, control passes to 712. In 712, it is determined whether the test drive was successful. In some embodiments, the test drive is determined to be successful in the event that all checklists are received from the mentor with satisfactory results. In the event the test drive is not successful, control passes to 718. In the event the test drive is successful, control passes to 714. In 714, it is determined whether the user is approved to drive. In some embodiments, determining whether the user is approved to drive comprises determining whether check list results indicate that the user is approved to drive. In the event that the user is not approved to drive, control passes to 718. In the event that the user is approved to drive, control passes to 716. In 716, the system indicates that the user is approved to drive, and the process ends. In 718, the system indicates that the user is not approved to drive.

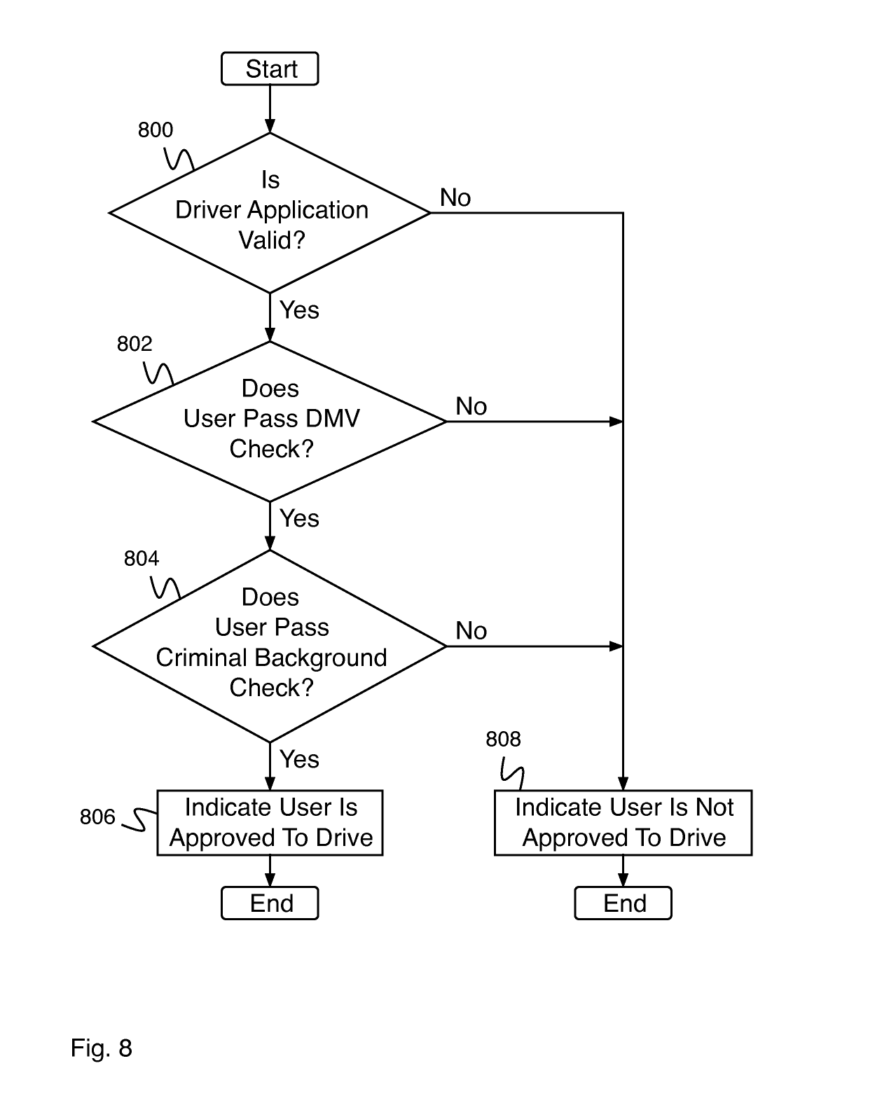

FIG. 8 is a flow diagram illustrating an embodiment of a process for determining whether a user is approved to drive. In some embodiments, the process of FIG. 8 implements 714 of FIG. 7. In the example shown, in 800, it is determined whether a driver application is valid. In various embodiments, determining whether a driver application is valid comprises determining whether a user is old enough, whether a user address comprises a valid address, whether a user consents to a DMV check, whether a user consents to a criminal background check, whether a user indicates that a car is of an appropriate age, or determining any other appropriate driver application information. In the event it is determined that a driver application is not valid, control passes to 808. In the event it is determined that a driver application is valid, control passes to 802. In some embodiments, a social media check is performed as part of determining whether a driver application is valid. In some embodiments, performing a social media check comprises evaluating social media information provided by the user. In 802, it is determined whether a user passes a DMV check. In some embodiments, a DMV check comprises checking a user record with a DMV. In various embodiments, a DMV check is executed for a user after the user provides the driver application, when the user begins a test drive, after a mentoring session is complete, or at any other appropriate time. In various embodiments, a completion time for a DMV check (e.g., how long it takes to receive DMV check results) comprises 10 seconds, 1 hour, 2 days, or any other appropriate completion time. In the event that it is determined that the user does not pass the DMV check, control passes to 808. In the event that it is determined that the user passes the DMV check, control passes to 804. In 804, it is determined whether the user passes a criminal background check. In some embodiments, a criminal background check comprises determining a user criminal history. In various embodiments, a criminal background check is executed for a user after the user provides the driver application, when the user begins a test drive, after a mentoring session is complete, or at any other appropriate time. In various embodiments, a completion time for a criminal background check (e.g., how long it takes to receive criminal background check results) comprises 1 minute, 1 hour, 2 days, 1 week, or any other appropriate completion time. In the event it is determined that the user does not pass the criminal background check, control passes to 808. In the event it is determined that the user passes the criminal background check, control passes to 806. In 806, the system indicates that the user is approved to drive, and the process ends. In 808, the system indicates that the user is not approved to drive.

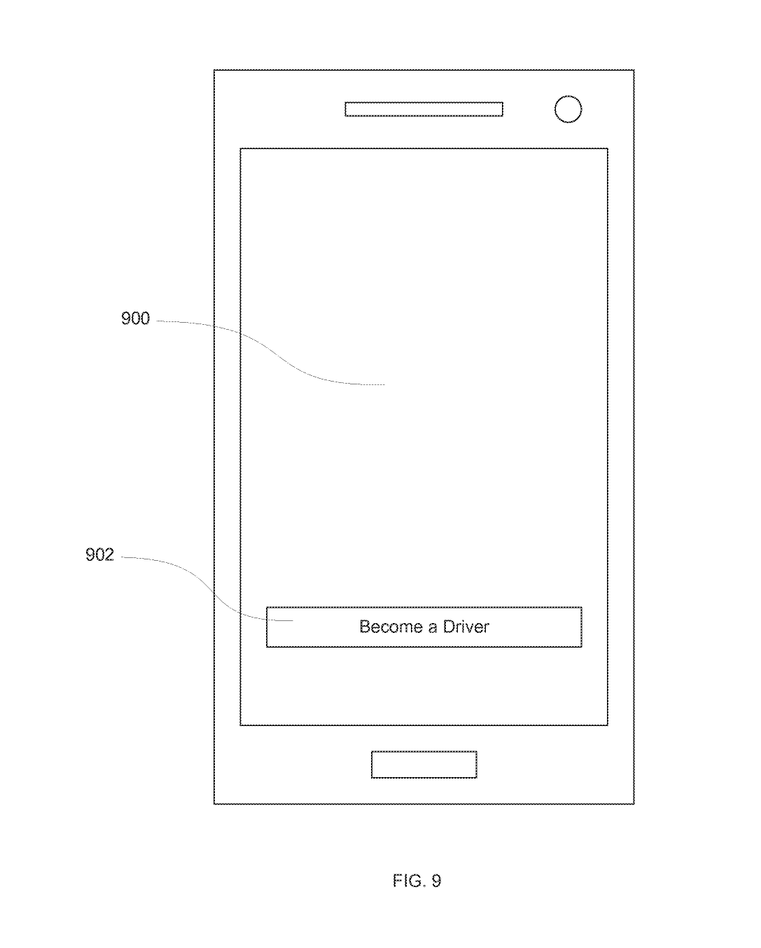

FIG. 9 is a diagram illustrating an embodiment of a system for driver screening. In some embodiments, display 900 comprises a display used by a driver desiring to be screened. In the example shown, display 900 of a device (e.g., a mobile computing device, a mobile phone, a cell phone, etc.) has button 902 for indicating a desire to become a driver (e.g., a rider that desires to be screened as a driver, a user that desires to be screened as a driver). In the event that a user selects button 902, an indication is transmitted from the device to a server (e.g., ride management system 106 of FIG. 1). The indication is received by the server and the server communicates with potential mentor drivers to arrange a screening. In the event that the mentor accepts to screen, the server automatically facilitates the screening.

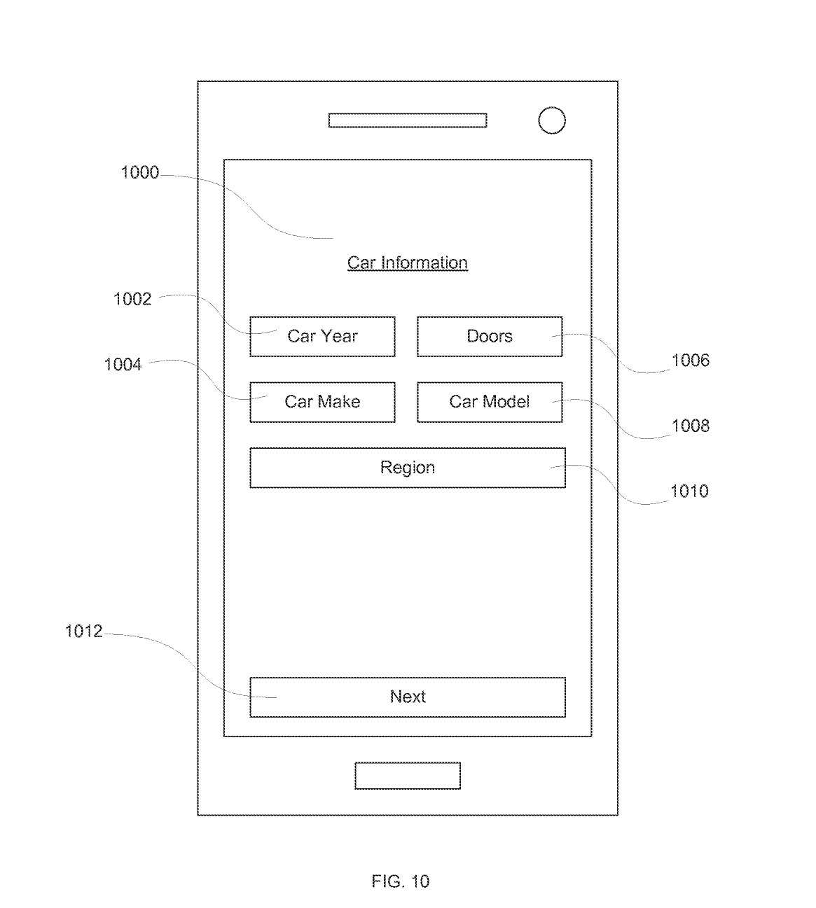

FIG. 10 is a diagram illustrating an embodiment of a system for driver screening. In some embodiments, display 1000 comprises a display used by a user desiring to be screened as a driver. In the example shown, display 1000 provides a visual interface for receiving information regarding the vehicle (e.g., the car of the potential driver) including car year 1002, car make 1004, doors 1006, car model 1008, and region 1010. The user or potential driver enters the car year in car year 1002, the car make in car make 1004, the car model in car model 1008, a number of car doors in doors 1006, and a region in which to provide rides in region 1010. The received information is transmitted to a server and stored and used to evaluate whether the user vehicle is appropriate. For example, a vehicle is not appropriate in the event that the car is older than a predetermined number of years (e.g., 4 years, 6 years, 10 years, etc.). Or for example, a vehicle is not appropriate in the event that the car does not have at least a predetermined number of doors (e.g., 4 doors). In the event that the vehicle is not appropriate, the server transmits an indication to the user via the user device where a notice is displayed indicating that the screening processes is terminating due to an inappropriate vehicle. In some embodiments, the information is transmitted to the server as a result of the user selecting (e.g., pressing) next button 1012.

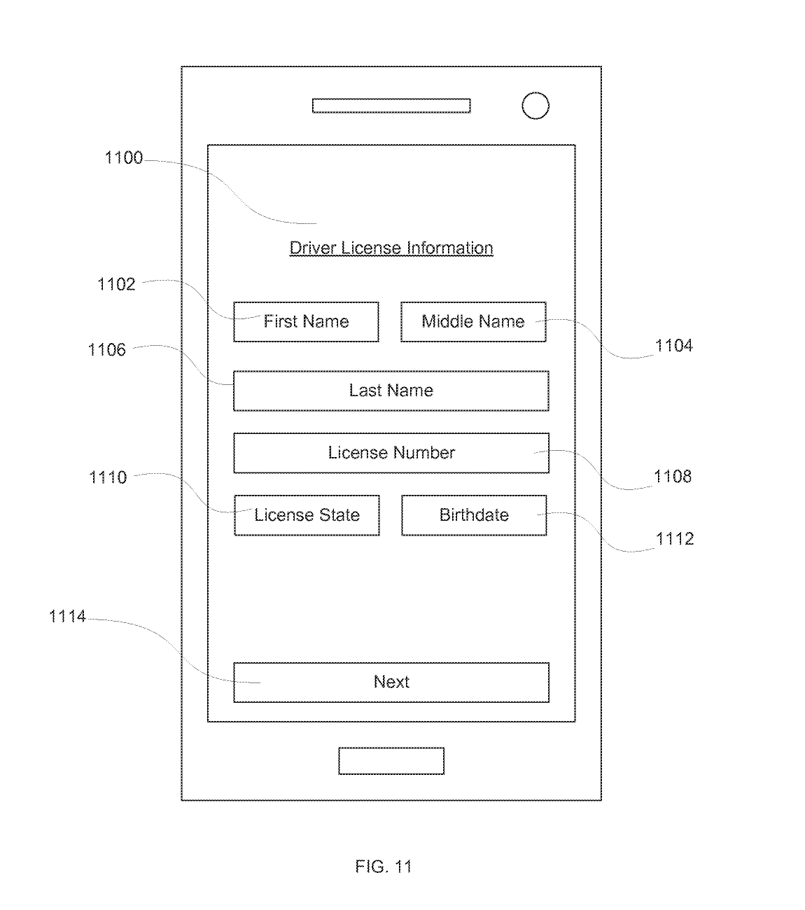

FIG. 11 is a diagram illustrating an embodiment of a system for driver screening. In some embodiments, display 1100 comprises a display used by a user desiring to be screened as a driver. In the example shown, display 1100 provides a visual interface for receiving information regarding a driver license (e.g., the driver's license of the potential driver) including first name 1102, middle name 1104, last name 1106, license number 1108, license state 1110, and birthdate 1112. The user or potential driver enters the first name in first name 1002, the middle name in middle name 1104, the last name in last name 1106, the license number in license number 1108, the license state in license state 1110, and the birthdate in birthdate 1112. The received information is transmitted to a server and stored and used to evaluate whether the user is appropriate for being a driver. For example, a user is not appropriate in the event that the license check shows an inappropriate driving record (e.g., a driving under the influence conviction, a number of violations greater than a threshold number of violations, etc.). Or for example, a user is not appropriate in the event that the user is not old enough. In the event that the user is not appropriate, the server transmits an indication to the user via the user device where a notice is displayed indicating that the screening processes is terminating due to an inappropriate driving background result or inappropriate age. In some embodiments, the information is transmitted to the server as a result of the user selecting (e.g., pressing) next button 1114.

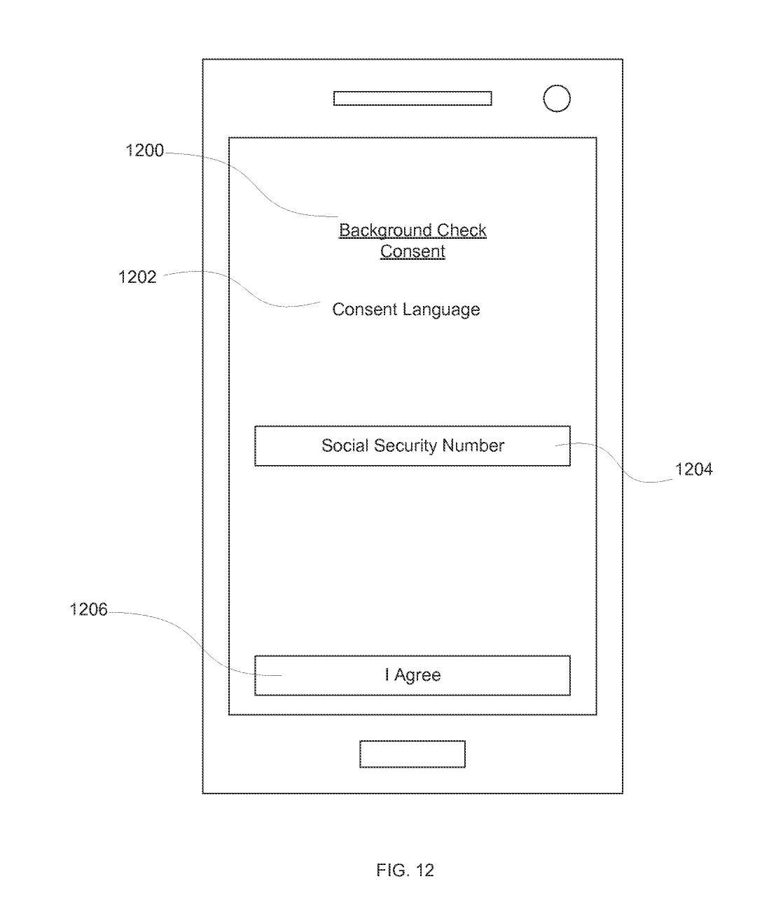

FIG. 12 is a diagram illustrating an embodiment of a system for driver screening. In some embodiments, display 1200 comprises a display used by a user desiring to be screened as a driver. In the example shown, display 1200 provides a visual interface for receiving information regarding a background check consent including social security number 1204 and for displaying consent language 1202. The user or potential driver enters their social security number in social security number 1204. The received information is transmitted to a server and stored and used to evaluate whether the user is appropriate for being a driver. For example, a user is not appropriate in the event that the background check shows an inappropriate criminal record (e.g., a felony conviction, a number of violations greater than a threshold number of violations, etc.). In the event that the user is not appropriate, the server transmits an indication to the user via the user device where a notice is displayed indicating that the screening processes is terminating due to an inappropriate background check result. In some embodiments, the information is transmitted to the server as a result of the user selecting (e.g., pressing) I agree button 1206.

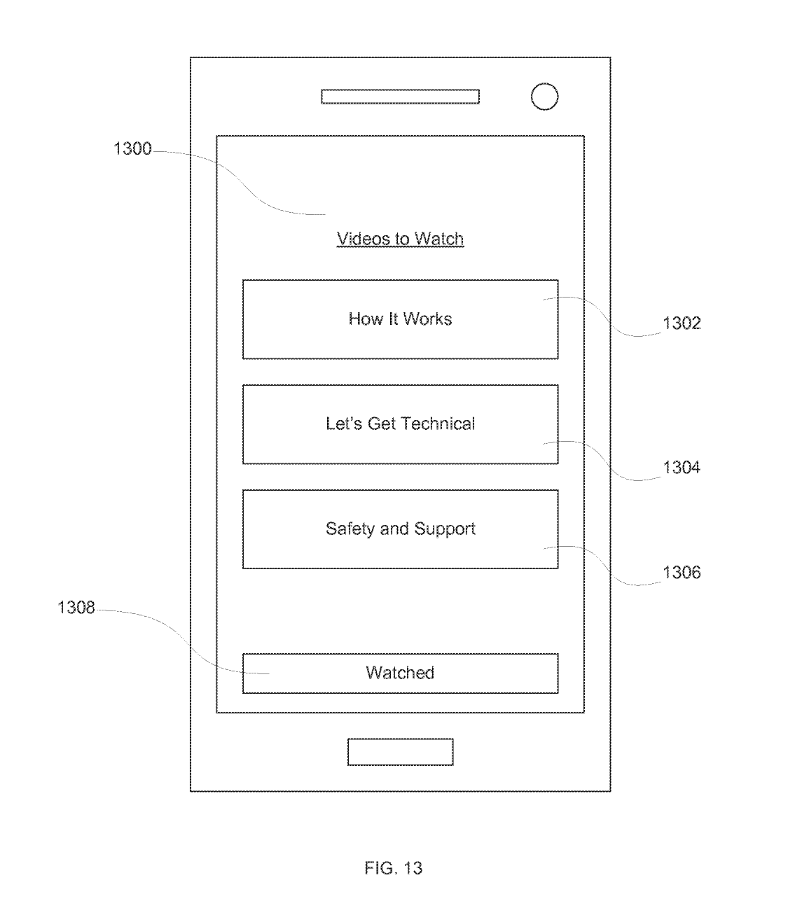

FIG. 13 is a diagram illustrating an embodiment of a system for driver screening. In some embodiments, display 1300 comprises a display used by a user desiring to be screened as a driver. In the example shown, display 1300 provides a visual interface for providing video information including How It Works video 1302, Let's Get Technical video 1304, and Safety and Support video 1306. The user or potential driver selects and watches each video which is provided by the server to the device of the user. It is determined whether the user has viewed the videos. For example, it is determined that the user watched a video by determining that a minimum time has elapse between the selecting to watch a video and the selection to watch a next video or the selection of any other button by a user (e.g., watched 1308). Or for example, it is determined that the user watched a video by determining that the user is able to answer questions regarding the content of the video right after completing viewing the video, when watched 1308 is selected, or prior to going on to a next step. In the event that the user did not watch the video, the server transmits an indication to the user via the user device where a notice is displayed indicating that the screening processes is terminating due to the fact that the videos were not watched. In some embodiments, the information is transmitted to the server as a result of the user selecting (e.g., pressing) watched 1308.

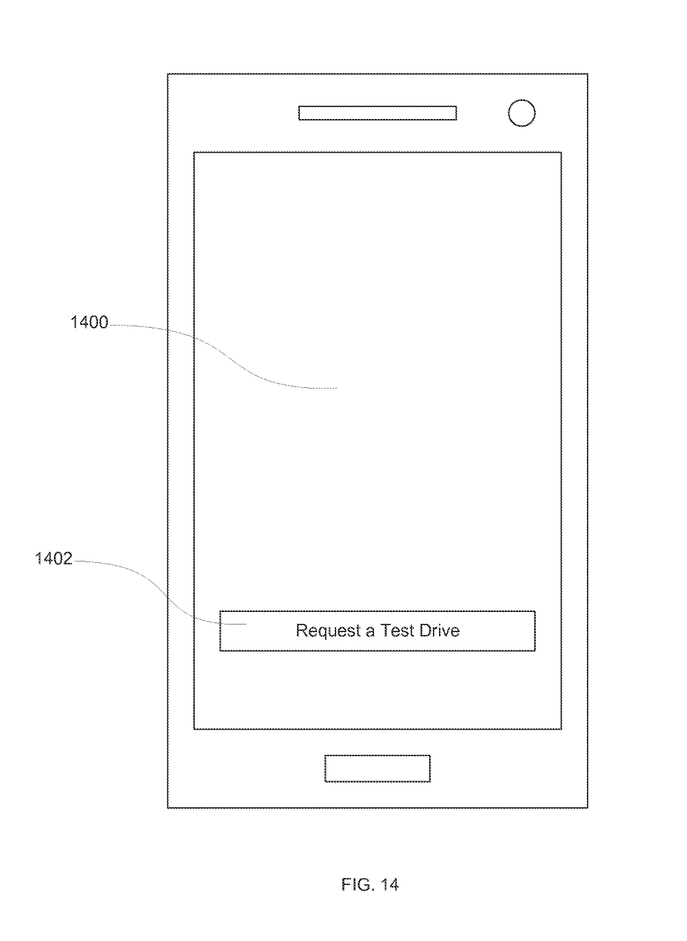

FIG. 14 is a diagram illustrating an embodiment of a system for driver screening. In some embodiments, display 1400 comprises a display used by a user desiring to be screened as a driver. In the example shown, display 1400 provides a visual interface for receiving a request for a test drive (e.g., a screening for a drive). The user or potential driver selects request a test drive 1402. An indication is transmitted to the server as a result of the user selecting (e.g., pressing) request a test drive 1402.

In some embodiments, a user is provided with an error message. In various embodiments, the error message comprises a message saying that the driver has failed the DMV check, that the DMV check had an error associated with it, that the request for a mentor must be retried during mentoring hours (e.g., 7 am to 5 pm, when a mentor is available, etc.).

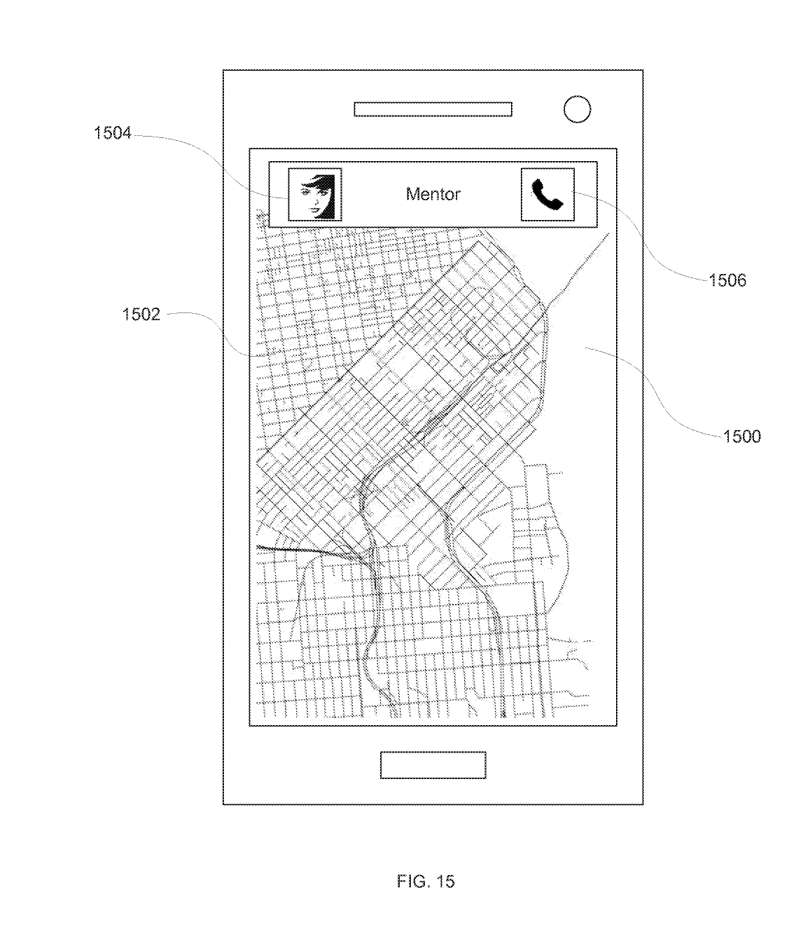

FIG. 15 is a diagram illustrating an embodiment of a system for driver screening. In some embodiments, display 1500 comprises a display used by a user desiring to be screened as a driver. In the example shown, display 1500 provides a visual interface for providing information including map 1502, mentor information 1504 (e.g., an image of the mentor), and phone button 1506. The user or potential driver is provided map 1502 showing where the mentor is (e.g., an indicator showing the location of the mentor, a route to the mentor, etc.), mentor information 1504 (e.g., a mentor image, a mentor name, etc.), and phone button 1506. In the event that phone button 1506 is selected, a phone call is initiated to the mentor. In some embodiments, display 1500 is updated with a position of the user as the user drives to pick up the mentor.

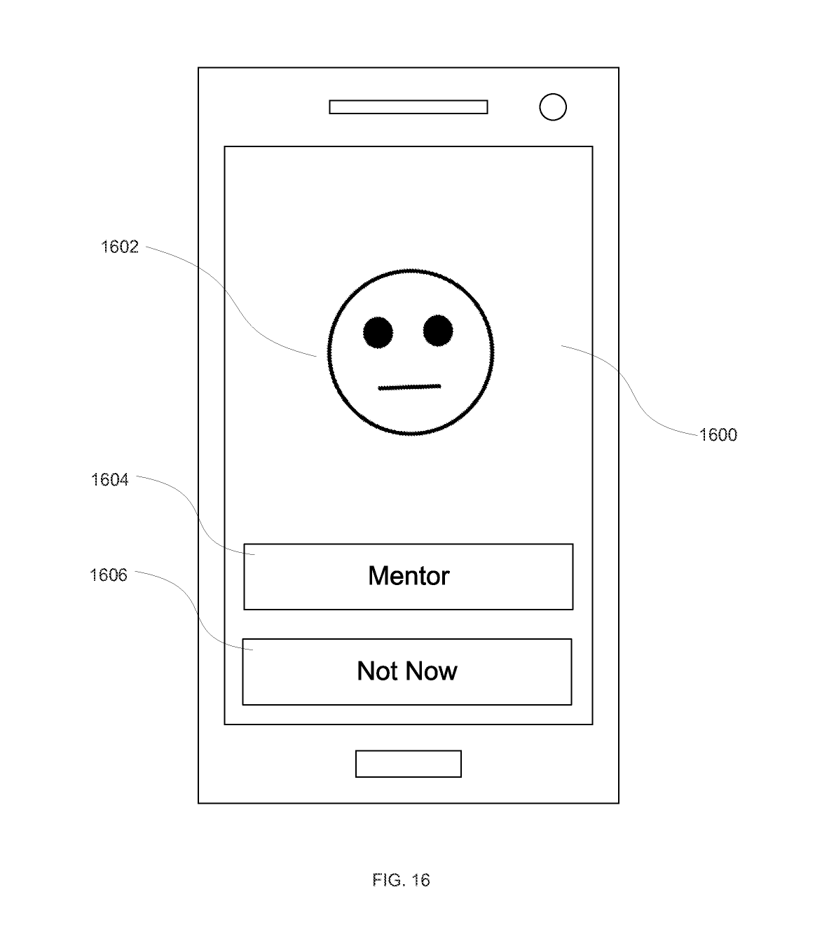

FIG. 16 is a diagram illustrating an embodiment of a system for driver screening. In some embodiments, display 1600 comprises a display used by a mentor screening a driver. In the example shown, display 1600 provides a visual interface for providing potential driver image 1602. Mentor indicates whether they want to mentor the applicant. In the event that the mentor taps mentor button 1604, the mentor and applicant are matched together and the mentor is provided a screen that shows the progress of the applicant driver to pick the mentor up (e.g., a map with an applicant position, a route to the mentor location, and an estimated time of arrival, applicant driver information, etc.). The applicant is provided a map that and an indication saying “Waiting for passenger requests”. The mentor then makes a ride request and the applicant is shown the location of the mentor, so the applicant can drive to the mentor. In the event that the mentor taps not now button 1606, the system receives an indication that the mentor is not available and the system attempts to match the applicant with a different mentor.

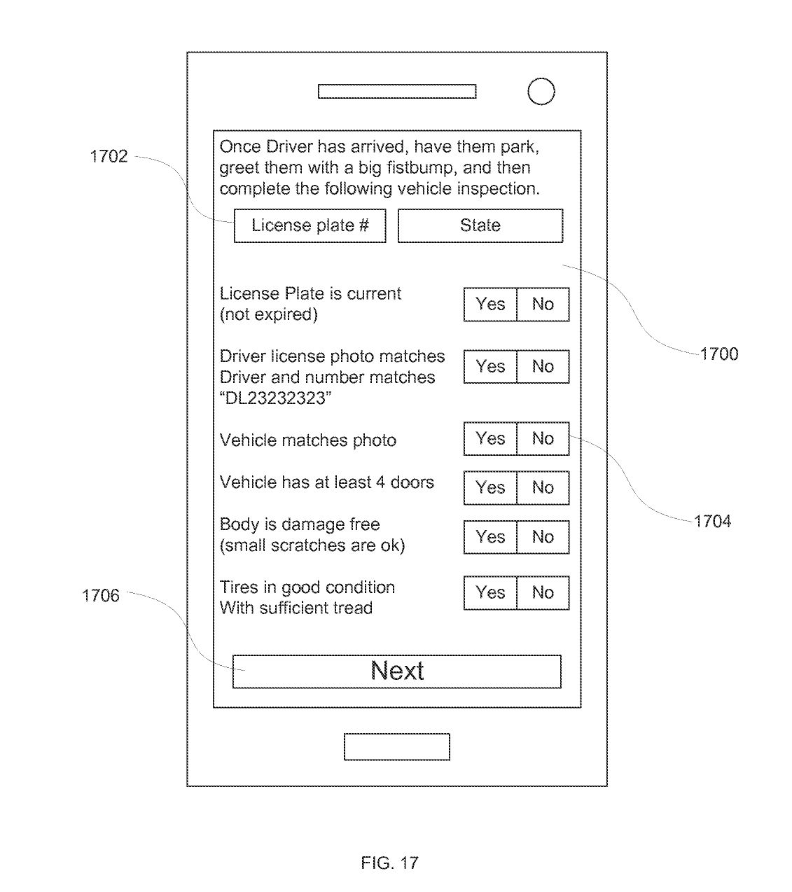

FIG. 17 is a diagram illustrating an embodiment of a system for driver screening. In some embodiments, display 1700 comprises a display used by a mentor screening a potential driver. In the example shown, display 1700 provides a visual interface for receiving and providing information regarding a vehicle including license plate number 1702, state, license plate current (not expired) and yes/no buttons, driver license photo matches driver and number matches a stored provided license number (e.g., received from potential driver system and stored on server) and yes/no buttons, vehicle matches photo and yes/no buttons 1704, vehicle has at least 4 doors and yes/no buttons, body is damage free (small scratches are ok) and yes/no buttons, tires in good condition with sufficient thread (e.g., greater than or equal to ⅛″ depth of tread), and a next button. The mentor enters license plate number and state of license and selects yes or no for each of the checklist questions regarding the vehicle. The received information is transmitted to a server and stored and used to evaluate whether the vehicle is appropriate for being used by a potential driver. For example, a vehicle is not appropriate in the event that any or a predetermined number checklist item(s) has/have a ‘no’ response. Or for example, a vehicle does not have 4 doors. In the event that the vehicle is not appropriate, the server transmits an indication to the user via the user device where a notice is displayed indicating that the screening processes is terminating due to the vehicle checklist not being passed. In some embodiments, the information is transmitted to the server as a result of the mentor selecting (e.g., pressing) next button 1706.

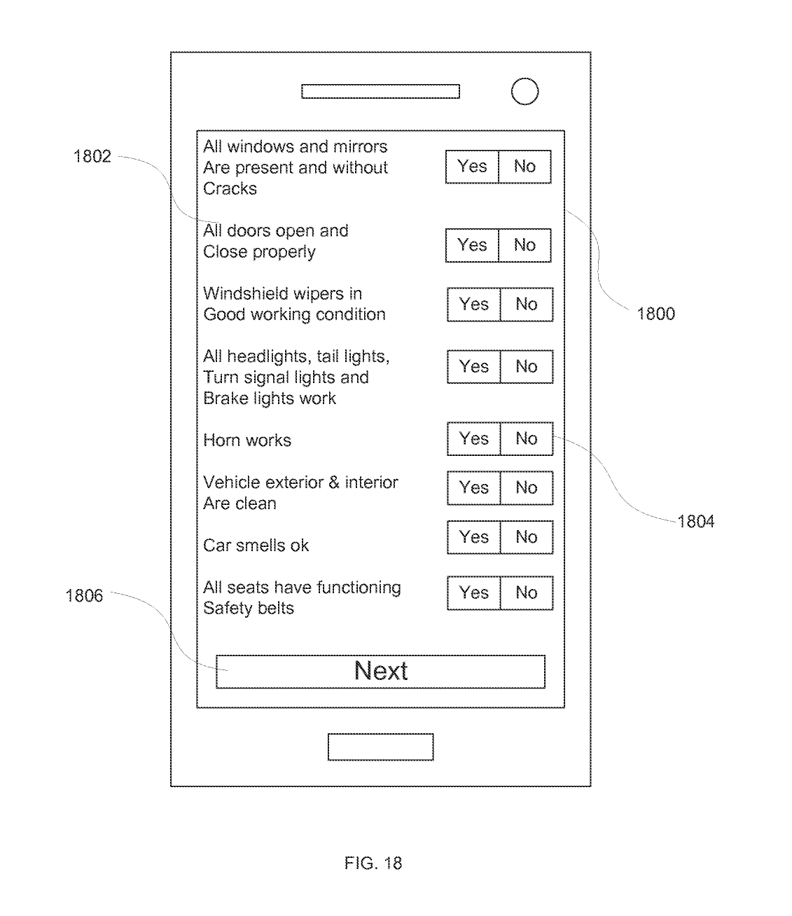

FIG. 18 is a diagram illustrating an embodiment of a system for driver screening. In some embodiments, display 1800 comprises a display used by a mentor screening a potential driver. In the example shown, display 1800 provides a visual interface for receiving and providing information 1802 regarding a vehicle including all windows and mirrors are present and without cracks and yes/no buttons, all doors open and close properly and yes/no buttons, windshield wipers in good working condition and yes/no buttons, all headlights, tail lights, turn signal lights and brake lights work and yes/no buttons, horn works and yes/no buttons 1804, vehicle exterior & interior are clean and yes/no buttons, car smells ok and yes/no buttons, all seats have functioning safety belts and yes/no buttons, The mentor selects yes or no for each of the checklist questions regarding the vehicle. The received information is transmitted to a server and stored and used to evaluate whether the vehicle is appropriate for being used by a potential driver. For example, a vehicle is not appropriate in the event that any or a predetermined number checklist item(s) has/have a ‘no’ response. In the event that the vehicle is not appropriate, the server transmits an indication to the user via the user device where a notice is displayed indicating that the screening processes is terminating due to the vehicle checklist not being passed. In some embodiments, the information is transmitted to the server as a result of the mentor selecting (e.g., pressing) next button 1806.

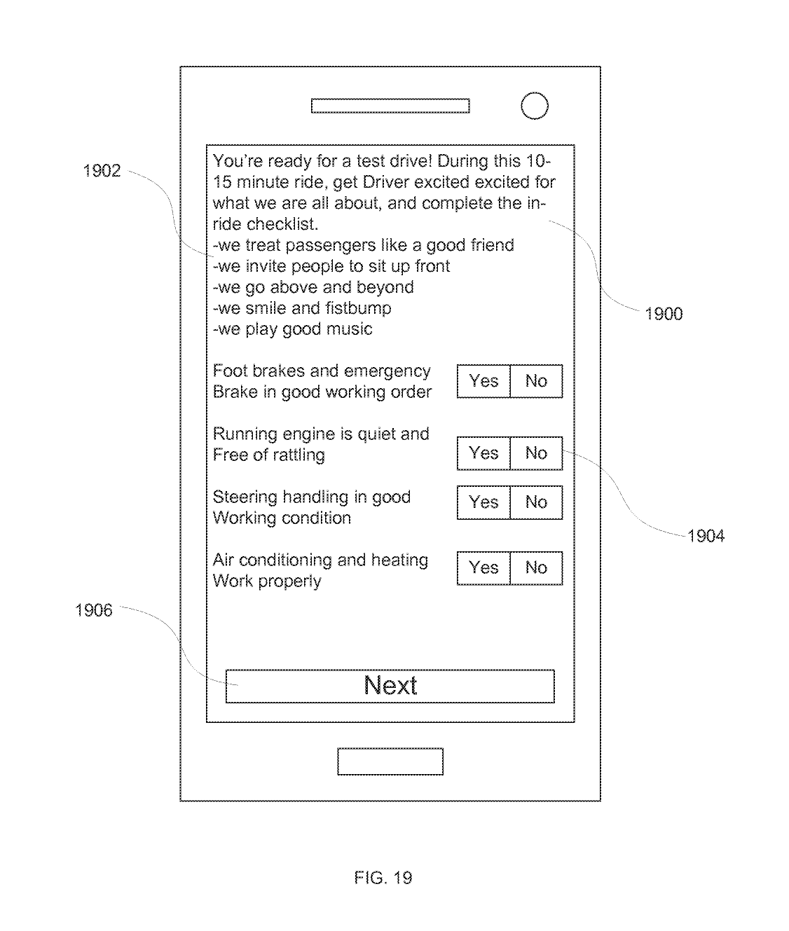

FIG. 19 is a diagram illustrating an embodiment of a system for driver screening. In some embodiments, display 1900 comprises a display used by a mentor screening a potential driver. In the example shown, display 1900 provides a visual interface for receiving and providing information regarding a test drive including instructions 1902, foot brakes and emergency brake in good working order and yes/no buttons, running engine is quiet and free of rattling and yes/no buttons 1904, steering handling in good working condition and yes/no buttons, air conditioning and heating work properly and yes/no buttons. The mentor selects yes or no for each of the checklist questions regarding the test ride. The received information is transmitted to a server and stored and used to evaluate whether the test ride is appropriate for a potential driver. For example, a test ride is not appropriate in the event that any or a predetermined number checklist item(s) has/have a ‘no’ response. In the event that the test ride is not appropriate, the server transmits an indication to the user via the user device where a notice is displayed indicating that the screening processes is terminating due to the test ride checklist not being passed. In some embodiments, the information is transmitted to the server as a result of the mentor selecting (e.g., pressing) next button 1906.

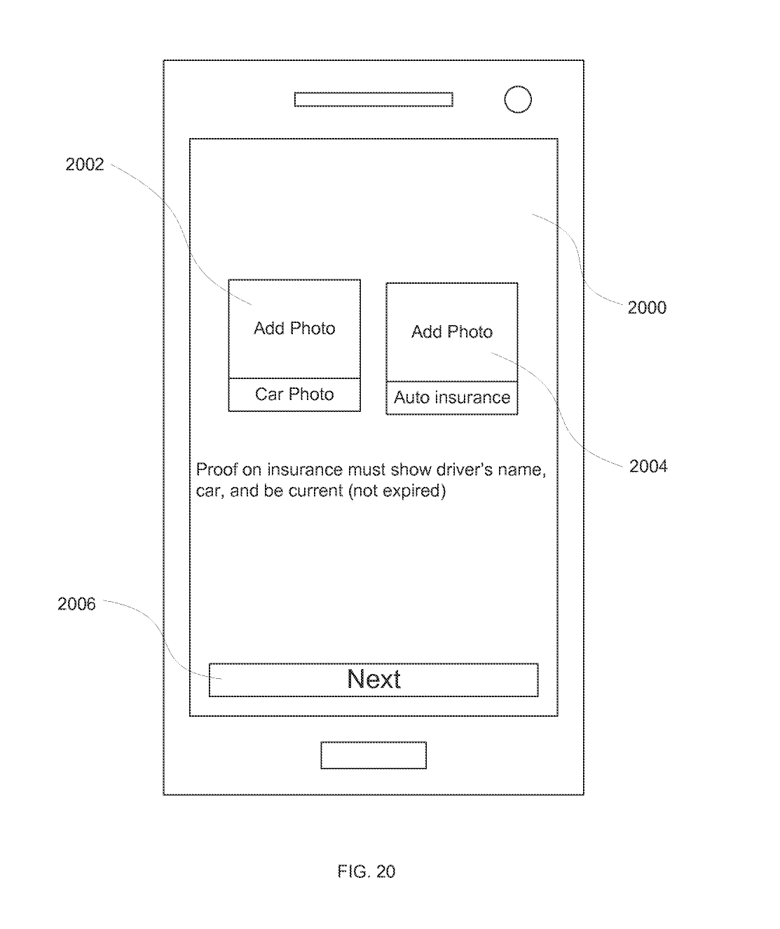

FIG. 20 is a diagram illustrating an embodiment of a system for driver screening. In some embodiments, display 2000 comprises a display used by a mentor screening a potential driver. In the example shown, display 2000 provides a visual interface for receiving information during a test drive including adding a car photo field 2002 and adding an auto insurance photo field 2004. The mentor selects to add an appropriate photo during a test ride. The mentor takes the photo and reviews the photo to see if it includes appropriate information (e.g., proof of insurance photo includes a driver's name, car, and is current, etc.). The received information is transmitted to a server and stored and used to evaluate whether the test ride is appropriate for a potential driver. For example, a test ride is not appropriate in the event that the photo is not uploaded. Or for example, a test ride is not appropriate in the event that the proof of insurance does not include the driver's name, driver's car, or is not current. In the event that the test ride is not appropriate, the server transmits an indication to the user via the user device where a notice is displayed indicating that the screening processes is terminating due to the test ride not being passed. In some embodiments, the information is transmitted to the server as a result of the mentor selecting (e.g., pressing) next button 2006.

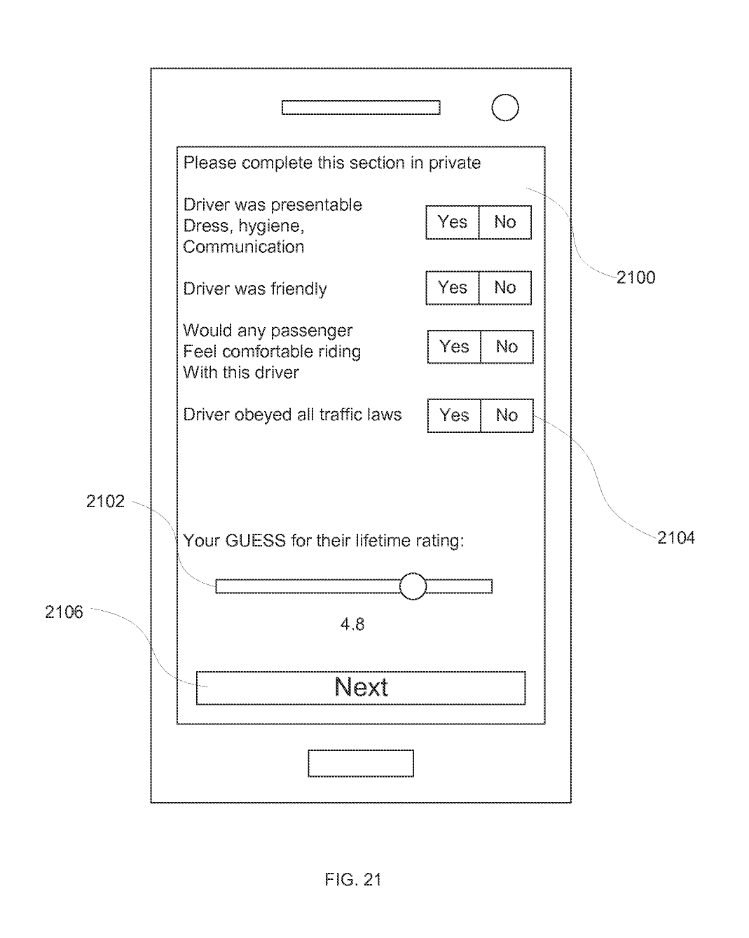

FIG. 21 is a diagram illustrating an embodiment of a system for driver screening. In some embodiments, display 2100 comprises a display used by a mentor screening a potential driver. In the example shown, display 2100 provides a visual interface for receiving information after a test drive including driver was presentable with dress, hygiene, communication and yes/no buttons, driver was friendly and yes/no buttons, would any passenger feel comfortable riding with this driver and yes/no buttons, driver obeyed all traffic laws and yes/no buttons 2104, and driver rating 2102. The mentor selects yes or no for each of the checklist questions regarding the test ride. The received information is transmitted to a server and stored and used to evaluate whether the test ride is appropriate for a potential driver. For example, a test ride is not appropriate in the event that any or a predetermined number checklist item(s) has/have a ‘no’ response. In the event that the test ride is not appropriate, the server transmits an indication to the user via the user device where a notice is displayed indicating that the screening processes is terminating due to the test ride not being passed. In some embodiments, the information is transmitted to the server as a result of the mentor selecting (e.g., pressing) next button 2106.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for driver screening, comprising:
an input interface configured to:
receive a driver application; and
receive an indication to start a test drive a driver with a mentor; and
a processor configured to:
determine that the test drive was successful; and
determine that the driver is approved to drive.

2. A system as in claim 1, wherein the processor is configured to provide video.

3. A system as in claim 2, wherein the processor is configured to determine whether the video has been watched.

4. A system as in claim 3, wherein determining whether the video has been watched comprises determining whether an indication is not received from the user within a predetermined minimum viewing amount of time.

5. A system as in claim 3, wherein determining whether the video has been watched comprises determining whether the user passes a quiz about the videos.

6. A system as in claim 1, wherein the processor is configured to determine whether a DMV check is passed.

7. A system as in claim 1, wherein the processor is configured to determine whether a criminal background check is passed.

8. A system as in claim 1, wherein determining that the driver is approved to drive comprises determining that a driver entered driver license number matches a license viewed by the mentor.

9. A system as in claim 1, wherein determining that the driver is approved to drive comprises determining that a driver photo matches the driver viewed by the mentor.

10. A system as in claim 1, wherein determining that the driver is approved to drive comprises determining that a vehicle of the driver passes a vehicle checklist.

11. A system as in claim 10, wherein determining that the vehicle passes the vehicle checklist comprises determining that the vehicle checklist received from a device of the mentor includes passing answers for at least a predetermined number of questions.

12. A system as in claim 1, wherein determining that the driver is approved to drive comprises storing a photo of the driver received from a device of the mentor.

13. A system as in claim 1, wherein determining that the driver is approved to drive comprises storing a photo of an insurance card of the driver received from a device of the mentor.

14. A system as in claim 1, wherein determining that the driver is approved to drive comprises determining that the driver passes a driver checklist.

15. A system as in claim 14, wherein determining that the driver passes the driver checklist comprises determining that the driver checklist received from a device of the mentor includes passing answers for at least a predetermined number of questions.

16. A system as in claim 1, wherein determining that the driver is approved to drive comprises determining that the driver passes a ride checklist.

17. A system as in claim 14, wherein determining that the driver passes the ride checklist comprises determining that the ride checklist received from a device of the mentor includes passing answers for at least a predetermined number of questions.

18. A method for driver screening, comprising:
receiving a driver application;
receiving an indication to start a test drive a driver with a mentor;
determining, using a processor, that the test drive was successful; and
determining that the driver is approved to drive.

19. A computer program product for driver screening, the computer program product being embodied in a tangible computer readable storage medium and comprising computer instructions for:
receiving a driver application;
receiving an indication to start a test drive a driver with a mentor;
determining, using a processor, that the test drive was successful; and
determining that the driver is approved to drive.
